(19) United States
(12) Patent Application Publication
(10) Pub. No.: US 2006/0254048 A1
(43) Pub. Date: Nov. 16, 2006

(54) Automatic electronic component supplying apparatus and components inventory management apparatus

(75) Inventor: Katsumi Shimada, Kasukabe-shi (JP)

Correspondence Address: NIXON PEABODY, LLP, 401 9TH STREET, NW, SUITE 900, WASHINGTON, DC, 20004-2128, US

(73) Assignee: Popman Corporation, Kasukabe-shi (JP)

(21) Appl. No.: 11/489,592

(22) Filed: Jul. 20, 2006

Related U.S. Application Data
(63) Continuation of application No. PCT/JP05/00955, filed on Jan. 26, 2005.

(30) Foreign Application Priority Data
Jan. 26, 2004 (JP) 2004-017539

(51) Int. Cl. B65G 47/24

(52) U.S. Cl. 29/740; 29/741; 29/744; 198/398

(57) ABSTRACT

An apparatus for supplying chip-type electronic components is disclosed. The apparatus comprises a square pipe having a passageway appropriate to the outer shape of chip-type electronic components and formed in such a way that the chip-type electronic components align in a single row within the passageway, a component pickup portion formed at one end portion of the square pipe for picking up the chip-type electronic components, a hopper attached at the other end of the square pipe in such a way that one end thereof can be attached and removed for storing the chip-type electronic components, a component supply device for supplying chip-type electronic components inside the hopper to the square pipe by moving at least one of either the other end portion of the square pipe or the hopper up and down, and a component conveying device for conveying the chip-type electronic components inside the passageway of the square pipe into the component pickup portion by introducing negative pressure air or positive pressure air into the square pipe or the hopper.

### TECHNICAL FIELD

The present invention relates to an automatic electronic component supplying apparatus and a components inventory management apparatus.

### BACKGROUND ART

Mounting of extremely large numbers of chip-type electronic components (also referred to simply as “chip components”) on printed wire boards has been practiced for some time. On such occasions, electronic component mounting devices (mounters) are used for the purpose mounting electronic components on printed wire boards.

Among electronic components, the components having the widest variety of types and greatest quantity of usage are passive components such as chip resistors and chip capacitors. According to METI's Current Production Trend Statistics, the number of chip components manufactured in Japan during the year running from January to December of 2002 was approximately 149.3 billion chip resistors and 264.0 billion chip capacitors (denoted as “ceramic capacitors” in the statistics). These are production volumes for chip-type electronic components in Japan; chip components also include a wide variety of components such as inductors and diodes, and the number of [all] chip-type electronic components manufactured globally, including Japan, is thought to reach 1 trillion per year.

Huge volumes and a large variety of chip components are almost all taped onto 8 mm wide tapes, supplied to mounters via tape feeders, and mounted on printed wire boards.

Taped component supply systems are thus now the main method for supplying chip components to the mounters.

With taped component supply systems, however, the costs for taping chip components as well as the costs of the taping material itself are high, making it difficult to reduce the cost of supplying components.

Additionally, in the taped component supply systems the components are supplied to the mounters on the reel packaging used for shipment by components manufacturers, as is, and after use the tapes are disposed as waste. The amount of tape waste from the one trillion chip components consumed each year is enormous in quantity, presenting an environmental protection issue as well as a high industrial waste disposal cost.

Furthermore, even though the external dimensions of chip components have been reduced through technical advances, reel holding sizes in the taped component systems are fixed, so storage space and distribution costs cannot be reduced.

In taped component supply systems, 180 mm diameter reels contain approximately 5000 to 10000 components per reel. Such reels are placed on a tape feeder and supplied at high speeds to a mounter. Some components may be mounted frequently, at a rate of several tens of components per printed wire board, whereas others may only be mounted infrequently, at a rate of one per printed wire board. If a component which is only mounted at a rate of one per printed wire board is supplied on a reel holding 5000 components, a single reel will only be completed after 5000 printed wire boards are mounted; component supply quantities cannot be freely selected.

There are also size limitations on reel diameter for high volume supply with taped component supply systems, making it difficult to process small supply quantity cover tapes. These systems are thus unsuitable for large and small volume supply. It is also impossible to add components midway during processing, raising the chance of component supply interruptions.

In taped component supply systems, the 8 mm tape feeder width is fixed by the tape width. Despite the advent of extremely small chip sizes, on the order of 0.4 mm long by 0.2 mm wide, tape widths have remained fixed at 8 mm. Since component supply density is determined by tape width, this results in low supply densities.

For this reason, installing tapes of the currently widespread 8 mm type for multiple component types on a mounter requires a large surface area for the mounter component supply portion, so that either the mounting head has to move over an extremely long distance in order to pick components or, in mounters with moveable component supply portions, the component supply portion is lengthened, causing mounter floor space area to increase. Increased size and length results in higher mounter cost.

When supplying many types of component, the low component supply density of tape supply systems makes it difficult to supply a variety of components, so that in practice several mounter units are linked in series to complete a single printed wire board. However, serially linking multiple mounters results in higher equipment costs, as well as imbalances between the mounting speeds of different mounters, making for difficult model changeovers and poor suitability to cell production.

8 mm tape feeders are also high in cost, and the total cost for mounters incorporating a large number of 8 mm tape feeders is extremely high. Another problem with 8 mm feeders is the excess number of stored chip components for low frequency use component.

Furthermore, mounters cannot be reduced in size because component supply devices have not gotten smaller despite advances in reducing the size of electronic equipment and of printed wire boards.

Paper waste stemming from paper tape is a cause of solder joint defects in high-density packaging.

Bulk feeders (electronic component supply devices) in which chip components are supplied to a mounter in a loose state without taping the chip components have been developed as new component supply systems to replace the above-described tape supply systems.

Such bulk feeder-based component supply systems are ground-breaking in comparison to tape supply systems: they produce no tape waste, they offer small component storage size (storage size is less than 1/10^{th} that of the tape supply system), and they enable taping cost to be eliminated (with tape supply systems, taping cost can make up 30% of total cost). Moreover, the selective supply of very large volumes down to very small volumes, which is difficult with tape supply systems, can be accomplished with bulk feed-based component supply systems.

However, even bulk feeder-based component supply systems have the following problems.

First, bulk feeders require alignment mechanisms for aligning components in a row, conveyor mechanisms for conveying components to a component pickup opening, separating mechanisms for separating components at the component pickup opening from those which follow thereafter, and the like, and are high in cost. They currently sell for more than twice the price of tape feeders, which is an impediment to the spread of bulk feeders.

In addition, bulk feeders are subject to chip component mixing errors by which the wrong components may be replenished when replenishing chip components to the hopper.

Another problem is the low reliability of bulk feeders due to the possibility of chip components becoming caught in the respective joint portions of alignment mechanisms, conveyance mechanisms, and separating mechanisms.

Yet another problem is that because the components are loose, friction between components or between components and the hopper may generate electrostatic charges.

Yet another problem is that because the components are loose, it is difficult to ascertain the amount of chip components used or the number of components remaining in the hopper.

Furthermore, the tape width of 8 mm is fixed and has not changed in tape component supply systems, notwithstanding that very small chip components on the order of 0.4 mm long and 0.2 mm wide are now available. Component supply density is therefore determined by tape width and is fixed, resulting in low supply densities.

The issues (problems) are thus that installing tapes of the currently widespread 8 mm type for multiple component types on a mounter requires a large surface area for the mounter component supply portion, and that in mounters with a fixed component supply portion, the distance moved by the mounting head to pick components is extremely long, while in mounters in which the component supply portion moves, the component supply portion becomes long, resulting in expanded floor space area for the mounter. Moreover, mounter costs increase when mounter size and length are increased.

### DISCLOSURE OF THE INVENTION

The present invention was thus undertaken to resolve the above-described problems. It is therefore an object of the present invention to provide a chip-type electronic component supply apparatus (bulk feeder) with high reliability and low cost.

It is a further object of the present invention to provide an electronic component supply apparatus capable of preventing erroneous mixing of chip-type electronic components.

It is a still further object of the present invention to provide an electronic component supply apparatus capable of supplying chip-type electronic components at a higher density compared to conventional tape feeders.

It is a still further object of the present invention to provide an electronic component supply apparatus capable of easily supplying selected quantities from large volumes down to small volumes.

It is a still further object of the present invention to provide a components inventory management apparatus capable of easily ascertaining the volume of chip-type electronic components used and the volume thereof remaining.

The above objects are achieved according to the present invention by providing an electronic component supply apparatus for supplying chip-type electronic components comprising a square pipe having a passageway appropriate to the outer shape of chip-type electronic components and formed in such a way that the chip-type electronic components align in a single row within the passageway, a component pickup portion formed at one end portion of the square pipe for picking up chip-type electronic components, a hopper attached at the other end of the square pipe in such a way that one end thereof can be attached and removed for storing the chip-type electronic components, a component supply device for supplying chip-type electronic components inside the hopper to the square pipe by moving at least one of either the other end portion of the square pipe or the hopper up and down, and a component conveying device for conveying the chip-type electronic components inside the passageway of square pipe into the component pickup portion by introducing negative pressure air or positive pressure air into the square pipe or the hopper.

According to the present invention thus constituted, at least one of either the other end portion of the square pipe or the hopper is first moved up or down by the component supply device, supplying the chip-type electronic components in the hopper into the square pipe passageway, then a negative air pressure or a positive air pressure is introduced into the square pipe or the hopper by the component conveying device, and the chip-type electronic components inside the square pipe passageway are conveyed to the component pickup portion. The chip-type electronic components are picked up by a mounter pickup nozzle at the component pickup portion.

The present invention uses seamless square pipe, causing chip-type electronic components to be arrayed in a row within the passageway portion of the square pipe, so that chip-type electronic components can be conveyed smoothly to the component pickup portion without getting caught, thereby increasing reliability. Because the hopper is detachably attached to the square pipe, replenishment of components can be performed with the hopper separated from the device, thus permitting reliable, error free replenishment using bar code systems or the like.

In the present invention, the component conveying device preferably includes an air pipe, detachably attached to the hopper, introducing positive air pressure into the hopper; and the air pipe can be selectively attached to the hopper and to the other end of a square pipe from which the hopper has been detached.

According to the present invention thus constituted, when the air pipe is connected to the other end of the square pipe, the chip-type electronic components inside the square pipe are conveyed to the component pickup portion by positive air pressure, so the square pipe becomes an electronic component supply device (bulk feeder) for small volume component supply, and is able to achieve low cost as well as high density.

Furthermore, the present invention preferably has a magnet device which is disposed in close proximity to the component pickup portion and holds chip-type electronic components in a component pickup position.

According to the present invention thus constituted, the chip-type electronic components can, using the magnet device, be securely held at the component pickup opening and accurately positioned.

The present invention preferably further comprises a flexible first tube connected to the other end of the hopper, a first component storing case detachably connected at one end of the first tube and holding chip-type electronic components for replenishment to the hopper, and a prevention device for preventing the escape to the outside of air from the first tube when the first component storing case is removed from the first tube.

According to the present invention thus constituted, the first component storing case, even if it has become empty, can be exchanged with the spare first component storing case during mounter operation without stopping the mounter.

The present invention preferably further comprises a flexible second tube connected to the other end of the first component storing case, and a second storing case detachably connected to the second tube, replenishing chip-type electronic components to the hopper via the first component storing case, and being larger in capacity than the first component storing case.

According to the present invention thus constituted, a high capacity second component storing case is serially linked to a first component storing case via the second tube, so the hopper, the first component storing case, and the large capacity second component storing case are at all times in communication. As a result, mixing in of other types of chip components during chip component replenishment can be avoided. Cases shipped by components manufacturers can also be used as a high capacity second component storing case. By so doing, mixing in of other types of chip components can be prevented.

In the present invention, the air pipe preferably supplies electrostatic charge-preventing material along with positive pressure air supplied to the hopper.

According to the present invention thus constituted, charging of the chip-type electronic components or the hopper can thus be effectively prevented.

In the present invention, the plurality of square pipes are preferably parallelly disposed in a planar direction, with the component pickup portions formed and the hoppers attached at each of the plurality of square pipes, whereby the component supply device cause the plurality of hoppers to move integrally up and down, supplying the chip-type electronic components in each of the hoppers to each of the square pipes; the component conveying device comprises a manifold communicating to each of the hoppers, with positive pressure air being introduced via the manifold into each of the hoppers, conveying the chip-type electronic components in the passageways of each of the square pipes to each of the component pickup portions, with all of the plurality of square pipes, the plurality of hoppers, the component supply device, and the component conveying device being formed so as to be capable of being disposed within a predetermined width in the planar direction.

According to the present invention thus constituted, the plurality of square pipes are disposed, and moreover, all of the plurality of square pipes, the plurality of hoppers, the component supply device, and the component conveying device are formed so as to be capable of being disposed within a predetermined width in the planar direction, resulting in a thin form and the ability to supply chip-type electronic components at a higher density than was done with conventional tape feeders.

In the present invention, the other end portion of the square pipe in the hopper is preferably formed such that only one of the faces forming the square pipe protrudes.

According to the present invention thus constituted, the other end portion of the square pipe in the hopper is formed so that only one face out of four faces protrudes, such that chip-type electronic components in the hopper can be easily urged into the square pipe.

The above object is achieved according to a second invention of the present invention by providing a components inventory management apparatus comprising a weight measurement device for measuring the weight of the hopper, and the first component storing case or the large capacity second component storing case along the chip-type electronic components stored therein, and a management device for managing chip-type electronic components consumption quantities and remaining held quantities of the chip-type electronic components in the first component storing case or the second component storing case, based on weight differentials before and after component supply to the hopper, the first component storing case, or the second component storing case.

According to the present invention thus constituted, the chip-type electronic components consumption quantities and chip-type electronic component quantities remaining in the hopper, the first component storing case, or the second component storing case can be managed based on weight differentials before and after component supply to the hopper, the first component storing case, or the second component storing case.

According to the chip-type electronic components supply apparatus (bulk feeder) of the present invention, reliability is high and cost is low, erroneous mixing of chip-type electronic components can be avoided, and large to small supply volumes can be easily selected.

According to the components inventory management apparatus of the present invention, it is easy to ascertain quantities of chip-type electronic components used and remaining.

### BRIEF DESCRIPTION OF THE DRAWINGS

In the accompanying drawings:

FIG. 1 is a partial sectional side view of an electronic components supply apparatus according to a first embodiment of the present invention, depicting the state wherein the hopper is in an upper position;

FIG. 2 is a partial sectional side view of an electronic components supply apparatus according to a first embodiment of the present invention, depicting a state wherein the hopper is in a lower position;

FIG. 3 is a partial sectional diagram depicting an electronic components supply apparatus in a state wherein, in the first embodiment, a hopper is detached and compressed air is being directly input into a square pipe from an air pipe;

FIG. 4 is a partial sectional side view of an electronic components supply device according to a second embodiment of the present invention, depicting a state wherein a component storing case is fixedly disposed;

FIG. 5 is a partial sectional side view of an electronic components supply device according to a second embodiment of the present invention, depicting a state wherein chip components in a component holding case are replenished to a hopper;

FIG. 6 is a partial sectional side view of an electronic components supply apparatus according to a third embodiment of the present invention;

FIG. 7 is a side view of an electronic components supply apparatus according to a fourth embodiment of the present invention; and

FIG. 8 is a partial plan view of the electronic components supply apparatus depicted in FIG. 7.

### BEST MODE FOR CARRYING OUT THE INVENTION

The preferred embodiments of the present invention will be explained with reference to the drawings.

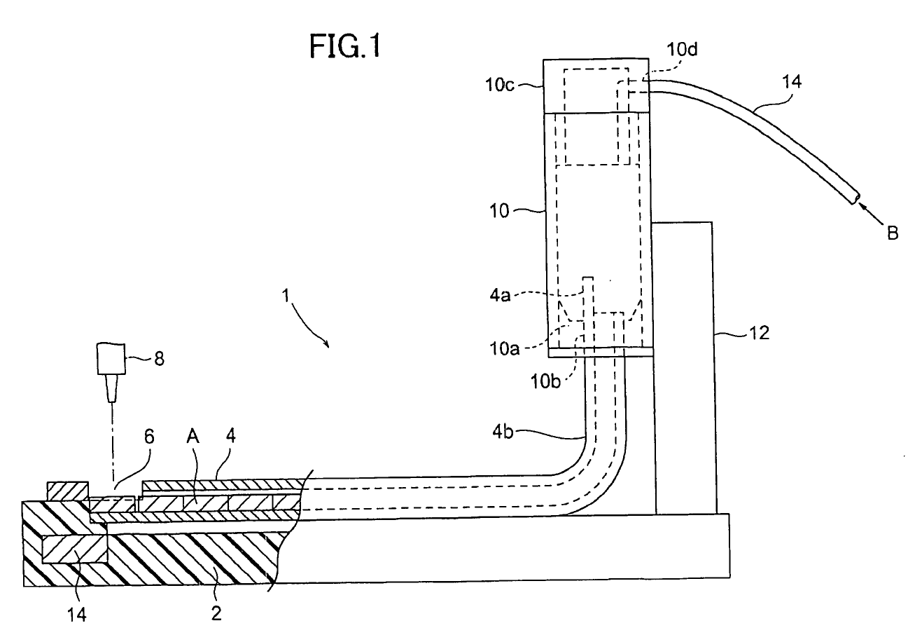

First, referring to FIGS. 1 through 3, a chip-type electronic component supply device for supplying chip-type electronic component according to a first embodiment of the present invention will be explained.

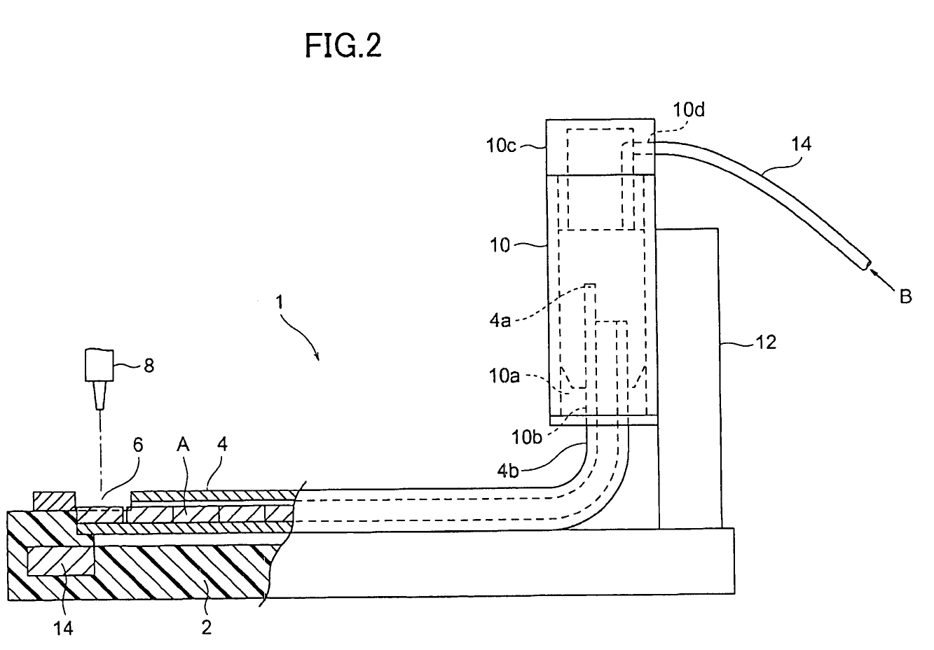

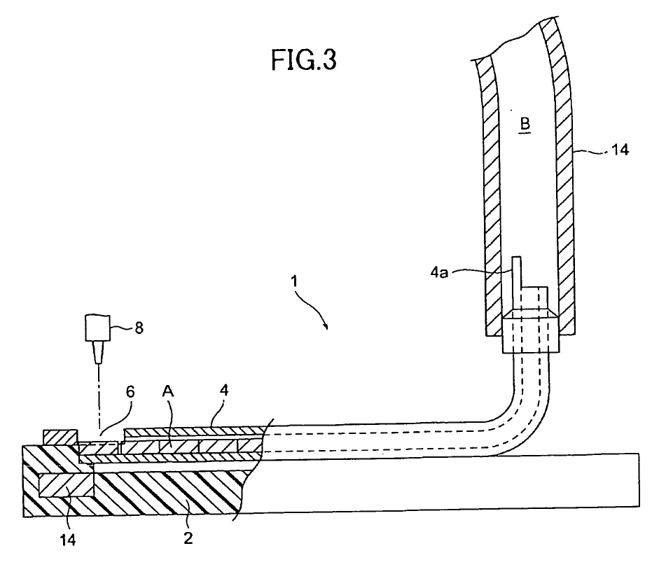

FIGS. 1 and 2 are partial sectional side views depicting an electronic component supply device according to a first embodiment of the present invention. FIG. 1 depicts a state in which the hopper is in an upper position; FIG. 2 depicts a state in which the hopper is in a lower position. FIG. 3 is a partial sectional side view depicting a state whereby, in the first embodiment, an electronic component supply device in the hopper is removed and compressed air is directly input to a square pipe from an air pipe.

As depicted in FIGS. 1 and 2, an electronic component supply device 1 comprises a fixedly disposed feeder base 2, with the electronic component supply device 1 disposed on a mounter (not shown) through the feeder base 2. A square pipe 4 is affixed to the feeder base 2, and the tip portion (one end portion) of the square pipe 4 is machined to form a component pickup opening 6. A mounter pickup nozzle 8 picks up chip-type electronic components A (chip components A) one by one from the component pickup opening 6 and mounts them on a printed wire board.

The back end portion (other end portion) of the square pipe 4 is bent upward (at approximately 90 degrees, for example), and a hopper 10 holding chip components in a loose state is detachably linked to the other end portion 4a (upper end portion) of the square pipe 4. A duct 10a is inserted into one end portion of the hopper 10, and a hole 10b fitting the external shape dimensions of the square pipe 4 is formed in the tube 10a.

Furthermore, a hopper drive device 12 comprising an air cylinder, a motor, and the like to move the hopper 10 up and down is disposed on the side portion of this hopper 10.

The other end portion 4b of the square pipe 4 is bent 90 degrees with respect to the horizontal plane as shown in the figure, so that the hopper 10 can be moved vertically up and down.

Here, the bending angle of the square pipe 4 other end side 4b and the up and down direction (angle) of the hopper 10 is not limited to 90 degrees, and may be any angle such that chip components A slide down under gravity within the square pipe 4. Those angles are preferably 60-90 degrees with respect to the horizontal plane.

The above-described hole 10b in the hopper 10 is formed with a gap tolerance such that not much compressed air in the hopper 10 will leak out even if the hopper 10 is moved up and down.

The square pipe 4 is a precision stainless square pipe formed by drawing, having a sectional shape such that a passageway has a shape fitting the external shape chip-type electronic component A (chip component A) and is capable of holding chip-type electronic components A aligned in a row. This square pipe 4 may also be a die-formed stainless square pipe.

The square pipe 4 other end portion (upper end portion) 4a in the hopper 10 is machined to fit chip component shapes in such a way that only one face of the four faces forming the square pipe protrudes, so as to achieve a high probability of urging in chip-type electronic components A.

In order to align the chip-type electronic components A in a single row in the passageway within the square pipe 4, it is sufficient for the square pipe 4 or the hopper 10 to be moved up or down. In the embodiment, as discussed above, movement up and down is achieved by affixing four square pipes 4 and driving the hopper 10 using the hopper drive device 12. The hopper 10 may also be fixed rather than moved up and down, instead providing a square pipe drive device (not shown) on the other end side 4b of the square pipe 4, causing the square pipe 4 other end side 4b to elastically deform by this square pipe drive device, thereby moving the square pipe 4 other end portion (upper end portion) 4a up and down.

Here, in the embodiment, the hopper 10 could also be grasped by hand and the hopper 10 moved up and down manually without using the above-described hopper drive device or square pipe drive device. In that case, the electronic component supply device (chip component bulk feeder) would be extremely low in cost.

A cover 10c is attached to the other end portion of the hopper 10; a compressed air intake port 10d is provided on this cover 10c, and an air pipe 14 for intermittently feeding compressed positive pressure air (compressed air) B is detachably disposed on the hopper 10. The biggest escape opening for the compressed air B is the passageway of each square pipe 4; otherwise there is only the gap between the square pipe 4 and the hopper 10 hole 10b. As a result, almost all the compressed air B is fed out via the square pipe 4 passageway. Compressed air B that passes through this passageway becomes the conveying device for chip components A guided into the square pipe 4, conveying the chip components A into the component pickup opening 6.

A magnet 14 is also disposed on the bottom of the component pickup opening 6 of the square pipe 4 in the embodiment, preventing chip components sent out at high momentum by compressed air B from flying out and holding the chip components securely in the component pickup opening 6 so that accurate positioning can be achieved.

Next, the operation of the embodiment described above will be explained. First, the hopper 10 is removed from the square pipe 4, then the cover 10c is removed from the hopper 10, chip components A are placed in the hopper 10, and the hopper 10 now holding the chip components is again connected to the square pipe 4. Next, using the hopper drive device 12, the hopper 10 is moved up and down and the chip components A in the hopper 10 are guided into the square pipe 4 passageway. Specifically, the hopper 10 makes a round trip in the up and down direction as depicted in FIG. 1 (hopper 10 in the upper position) and FIG. 2 (hopper 10 in the lower position).

Furthermore, at the same time that the hopper 10 is moved up and down by the hopper drive device 12, compressed positive pressure air B is conducted into the hopper 10 from the air pipe 14. This compressed air is synchronized to the component picking operation of the above-described mounter pickup nozzle 8, and is intermittently guided inward. As a result, when the mounter pickup nozzle 8 picks up chip components A at the component pickup opening 6, the next chip component A is at the same time positioned at the component pickup opening 6.

Next, as depicted in FIG. 3, the hopper 10 in the embodiment is removed from the square pipe 4 after the chip components A are aligned in a row inside the square pipe 4 passageway by the up and down movement of the hopper 10. In this state, the air pipe 14 may be connected directly to the square pipe 4 other end portion 4a. In this case, compressed air B from the air pipe 14 is directly supplied into the passageway of the square pipe 4, so the chip components A are conveyed inside the square pipe 4 to the component pickup opening 6.

In the embodiment, a plurality of square pipes 4 may be disposed adjacently and at high density, the hopper 10 connects to a square pipe 4 temporarily for only the time needed to replenish chip components, the chip components A are replenished to the square pipe 4, and thereafter the hopper may be removed from the square pipe 4. When this happens, as described above, the air pipe 14 is attached to the square pipe 4 and compressed positive pressure air B from the air pipe 14 is directly supplied into the passageway of the square pipe 4. In this example, the electronic component supply device is a bulk feeder with extremely high density and low cost.

Because the hopper 10 can be removed from the square pipe 4, measuring weight with a precise scale before and after supply of hopper 10 components enables easy determination of the quantity of chip components A consumed and the quantity thereof remaining in the hopper 10, so that accurate and simple components inventory management can be effected.

According to the embodiment, seamless square pipes 4 are used to cause chip components to be aligned in a row inside the square pipe 4 passageway, so that chip components can be smoothly conveyed to the component pickup opening 6 without catching, and reliability is improved.

The hopper 10 is detachably attached to the square pipe 4, so that when replenishing chip components to the hopper 10, the components can be replenished with the hopper 10 removed from the device, such that certain, error-free component replenishment can be effected using a bar code management system or the like.

A magnet 14 is disposed on the lower part of the component pickup opening 6 of the square pipe 4, enabling reliable holding by the component pickup opening 6 of chip components for accurate positioning.

Moreover, in the embodiment the hopper 10 is removed from the square pipe 4 after aligning the chip components A in a row within the square pipe 4 passageway; in this state, the air pipe 14 may be directly connected to the square pipe 4 other end portion 4a. In this case the square pipe 4 becomes a bulk feeder for small quantity component supply, enabling the provision of a low cost, high density bulk feeder. The compressed positive pressure air B from the air pipe 14 in this case is supplied directly into the square pipe 4 passageway, so that chip components A are conveyed up to the component pickup opening 6 through the square pipe 4.

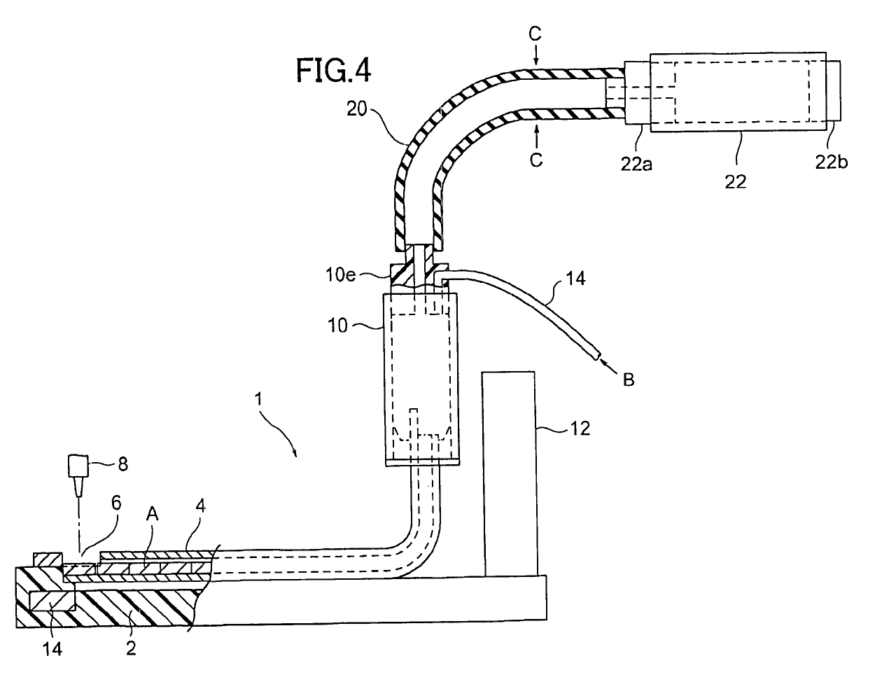

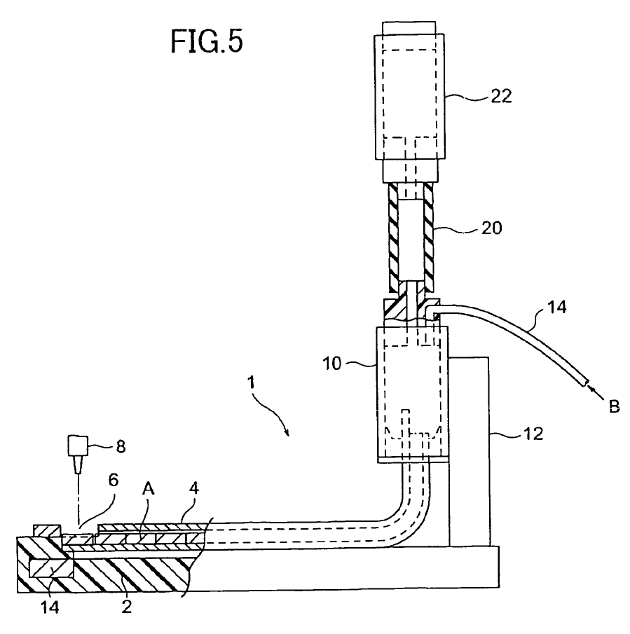

Next, an electronic component supply device according to a second embodiment of the present invention will be explained with reference to FIGS. 4 and 5. FIGS. 4 and 5 are partial sectional side views depicting an electronic component supply device according to a second embodiment of the present invention. FIG. 4 depicts the state in which a component holding case is fixedly disposed, and FIG. 5 depicts the state in which chip components in a component holding case are replenishing a hopper.

The basic structure of the second embodiment is the same as that of the first embodiment, only the differing portions will be discussed here.

In the second embodiment, a duct 10e is attached to the other end portion of the hopper 10 in lieu of a cover 10c, and an air pipe 14 is detachably attached to this duct 10e. One end of a flexible rubber tube 20 is connected to this hopper 10 duct 10e, and a component storing case 22 is attached to the other end portion of the rubber tube 20. A duct 22a is attached at one end portion of the component storing case 22, and a cover 22b is attached to the other end portion thereof; the rubber tube 20 is connected to this duct 22a.

Here, when the mounter is in operation the component storing case 22 is normally fixedly disposed while the hopper 10 moves up and down. The flexibility of the rubber tube 20 causes it to perform a shock aborbing role between the hopper 10 and the component storing case 22.

The cross sectional area of the respective portions of the duct 10e, the rubber tube 20, and the duct 22a through which the chip components A pass are set to be large enough to allow the passage of a plurality of chip components A simultaneously. The description in FIGS. 4 and 5 is narrower than the actual devices.

Next, the operation of the second embodiment will be explained. First, compressed positive pressure air B, intermittently supplied to the hopper 10 from the air pipe 14 is captured by the component holding case 22, the rubber tube 20, and the hopper 10, so that compressed air B for conveying the above-described chip components is fed through only the square pipe 4 passageway. The compressed air B which passes through that square pipe 4 passageway delivers chip components A guided through the square pipe 4 to the component pickup opening 6.

Next, when the quantity of chip components A in the hopper 10 is depleted in the hopper 10 while the mounter is operating, chip components A should be fed from the component storing case 22 to the hopper 10. In that case, as shown in FIG. 5, the component holding case 22 is caused to move above the hopper 10, such that the chip components A in the component storing case 22 drop down under their own weight into the hopper 10. Bringing the component storing case 22 to a position above the hopper 10 may be accomplished manually by an operator, or a component storing case drive device (not shown) may be provided, and the component storing case 22 may be moved automatically by operating this drive device.

To limit the quantity of chip components A to be replenished in the hopper 10, an operator may control the quantity of chip components falling by crimping the rubber tube 20 with his/her finger at point C.

Moreover, when the component holding case 22 becomes empty during mounter operation, the emptied component holding case 22 is exchanged with a spare component holding case 22 which has been previously filled with chip components, without stopping the mounter. At this point it is necessary in order to keep the compressed positive pressure air B in the hopper 10 from escaping outside the square pipe 4 passageway to crimp point C with a finger or clip-type object.

According to the second embodiment, when the component storing case 22 becomes empty during mounter operation, it can be replaced by a spare component storing case 22 without stopping the mounter.

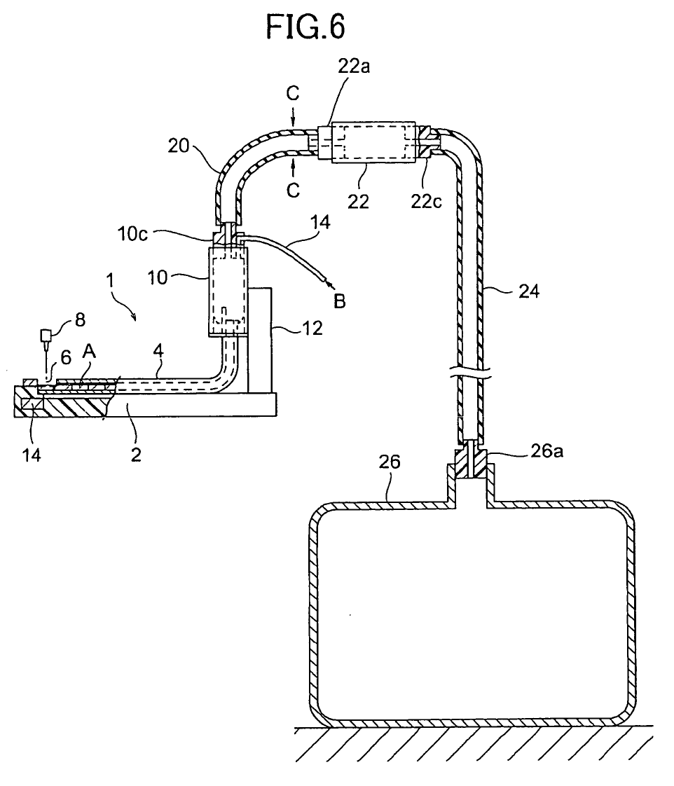

Next, an electronic component supply device according to a third embodiment of the present invention will be explained with reference to FIG. 6. FIG. 6 is a partial sectional diagram depicting an electronic component supply device according to a third embodiment of the present invention. The basic structure of the third embodiment is the same as that of the first and second embodiments, therefore only those portions which differ from the second embodiment will be described.

In the third embodiment, a duct 22c is attached at the other end of the component storing case 22 in lieu of a cover 22b. One end portion of the flexible rubber tube 24 is connected to this duct 22c, while the other end portion of the rubber tube is connected to a large capacity component storing case 26. Here, a duct 26a is attached to the large capacity component storing case 26, and the rubber tube 24 is connected to this duct 26a.

The sectional area of portions through which chip components A pass between the hopper 10 and the large capacity component storing case 26, which is to say the duct 10e, the rubber tube 20, the duct 22a, the duct 22c, the rubber tube 24, and the like, is set to a size such that multiple chip components A can pass simultaneously. The description in FIG. 6 is narrower than the actual devices.

In this embodiment, furthermore, a large volume of chip components A can be supplied continuously without changing the component storing case 22 and without stopping the mounter.

Specifically, because the large capacity component storing case 26 is linked to the component storing case 22 via the rubber tube 24, the hopper 10, the component storing case 22, and the large capacity component storing case 26 are always in communication.

As a result, mixing in of other types of chips during chip component replenishment can be avoided. For example, if the large capacity component storing case 26 is placed on a floor 28, continuous operation over a considerable length of time can be achieved by placing a considerable amount of chip components therein without replenishment of the large capacity component storing case 26.

Cases shipped from components manufacturers can also be connected in place of the large capacity component storing case 26. This enables prevention of mixing in of other types of chip components.

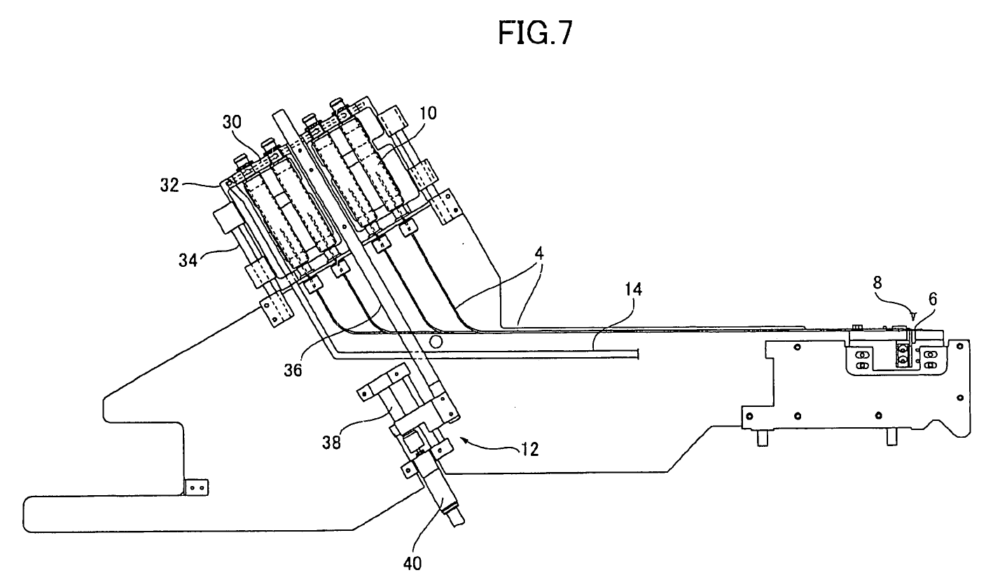

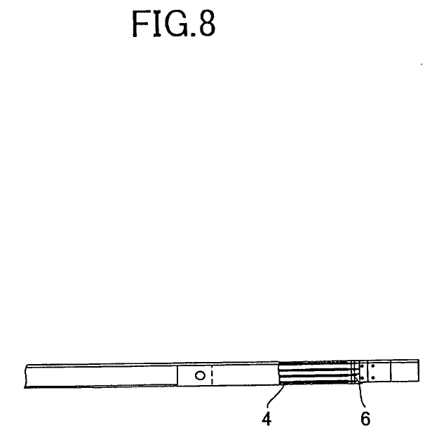

Next, referring to FIGS. 7 and 8, an electronic components supply device according to a fourth embodiment of the present invention will be explained. FIG. 7 is a side view depicting an electronic components supply device according to a fourth embodiment of the invention; FIG. 8 is a partial plan view of the electronic components supply device depicted in FIG. 7

As shown in FIGS. 7 and 8 of the fourth embodiment, four square pipes 4 bent by 60 degrees are disposed adjacently in the planar direction. Moreover, a component pickup opening 6 is formed on each of these square pipes 4, and a hopper 10 is attached thereto. Thus in embodiment provides four square pipes 4, four component pickup openings 6, and four hoppers 10.

Additionally, a manifold 30 is provided to communicate with each of the four hoppers 10, and positive pressure air is introduced into these manifolds 30 from a single air pipe 14. Each of these four hoppers 10 and manifold 30 are integrally held by a hopper unit 32, and are disposed along a guide piece 34 so as to be capable of up and down movement.

This hopper unit 32 is driven up and down by a hopper drive device 12. The hopper drive device comprises a drive piece 36, the top end of which is attached to the hopper unit 32, a twist screw 38 linked on the other end to the other end of the drive portion piece 36, and a DC motor 40 directly connected to this twist screw 38.

The electronic components supply device according to the fourth embodiment is thin formed; the entire four square pipes 4, four hoppers 10, and all of the hopper units 32 with manifold 30 attached are formed to be less than 14 mm in width.

Next, the operation of the fourth embodiment will be explained. Positive pressure air is fed from a single air pipe 14 through a manifold 30 to the four hoppers 10. Positive pressure air fed to the hopper 10 flows through the square pipes 4 and out to the atmosphere from the component pickup openings 6. This positive pressure air and the air current of the air in the square pipes 4 convey the chip components A arrayed in a row in the square pipes 4 to the component picking ports 6. Center spacing between the square pipes is set at 3.6 mm to hold the four square pipes 4 within the 14 mm wide base. Most single 8 mm tape feeders are normally between 15 and 20 mm in width, in which case chip components A four times the width of the tape feeder can be supplied to the automatic mounting device from the component pickup openings 6. After the automatic mounting device pickup nozzle 8 picks up a chip component, high speed, continuous pick up from a single pipe can be accomplished by moving positive pressure air a distance of approximately 25 mm. The hopper drive device 12 cause the drive piece 36 to move up and down so that the four hoppers 10 travel back and forth over a stroke of approximately 20 mm. Chip components A are urged into the square pipe 4 by this hopper stroke movement (up and down movement). In the embodiment, all of the four square pipes 4, the four hoppers 10, and the hopper unit 32 with manifold 30 attached in the electronic component supply device are formed to have a width of 14 mm or less, such that the mechanism has a thin form, capable of high density supply four times that of a tape feeder, with a simple mechanism so that a low cost bulk feeder is achieved.

Next, in the embodiments 1 through 4 of the present invention described above, the hopper 10 and the component storing case 22 are fabricated with commercially sold acrylic pipe having an outer diameter of 12 mm, an inner diameter of 10 mm, and a length of 60 mm, and the hopper 10 duct 10a, cover 10c, and duct 10e, as well as the component storing case 22 duct 22a, the cover 22b, and the duct 22c, are fabricated as plastic molded parts.

By so doing, a high density electronic components supply device (bulk feeder) can be fabricated at an extremely low cost, due to its simple structure and low materials cost.

In the above-described embodiments of the present invention, it is also easy for friction to arise between chip components A or between chip components A and the inside wall of the hopper 10 due to the up and down movement of the hopper 10, thereby generating static electricity. An electrostatic charge preventing material (not shown) is therefore mixed in with the intermittently supplied compressed positive pressure air B in the hopper 10 to effectively prevent charging of the chip components A or the hopper 10.

In the above-described embodiments of the present invention, the compressed positive pressure air was intermittently supplied into the hopper 10, and the chip components A aligned within the square pipe 4 were conveyed to the component pickup opening 6, but there is no such limitation in the present invention. In other words, an air pipe opening is provided which opens at its end portion in the vicinity of a feeder base 2 component pickup opening 6, and by intermittent supply of negative pressure from this air pipe, chip components A aligned in a square pipe 4 passageway can be suctioned and conveyed to a component pickup opening 6 position.

In embodiments of the present invention, the hopper 10, the component storing case 22, and the large capacity component storing case 26 are each disposed so as to be detachable from the device, so that the hopper 10, the component storing case 22, and/or the large capacity component storing case 26 is/are first weighed before supplying chips, following which chip components are supplied by operating the mounter. Then, with the mounter stopped, the hopper 10, the component holding case 22 and/or the large capacity component storing case 26 are together weighed along with the chip-type electronic components held therein. Chip-type electronic component consumption quantities and remaining quantities on hand of the chip-type electronic components in the hopper 10, the component storing case 22, and the large capacity component storing case 26 can be managed based on the weight differential between the above two states.

1. An apparatus for supplying chip-type electronic components, comprising:
a square pipe having a passageway appropriate to the outer shape of chip-type electronic components and formed in such a way that the chip-type electronic components align in a single row within the passageway;
a component pickup portion including a component pickup opening formed at one end portion of the square pipe for picking up the chip-type electronic components;
a hopper attached at the other end of the square pipe in such a way that one end thereof can be attached and removed for storing the chip-type electronic components;
a component supply device for supplying chip-type electronic components inside the hopper to the square pipe by moving the hopper up and down; and
a component conveying device for conveying the chip-type electronic components inside the passageway of the square pipe to the component pickup opening of the component pickup portion by introducing positive pressure air into the hopper and capturing the positive air in the hopper so that the positive pressure air is fed through the passageway of the square pipe.

2. An apparatus according to claim 1, wherein said component conveying device includes an air pipe, detachably attached to the hopper, introducing positive air pressure into the hopper, and said air pipe can be selectively attached to the hopper and to the other end of a square pipe from which the hopper has been detached.

3. An apparatus according to claim 1, wherein said apparatus further comprises a magnet device which is disposed in close proximity to the component pickup portion and holds chip-type electronic components in the component pickup position.

4. An apparatus according to either one of claim 1, wherein said apparatus further comprises a flexible first tube connected to the other end of the hopper, a first component storing case detachably connected at one end of the first tube and storing chip-type electronic components for replenishment to the hopper, and a prevention device for preventing the escape to the outside of air from the first tube when the first component storing case is removed from the first tube.

5. An apparatus according to claim 4, wherein said apparatus further comprises a flexible second tube connected to the other end of the first component storing case, and a second storing case detachably connected to the second tube, replenishing the chip-type electronic components to the hopper via the first component storing case, and being larger in capacity than the first component storing case.

6. An apparatus according to claim 2, wherein said air pipe supplies electrostatic charge-preventing material along with the positive pressure air supplied to the hopper.

7. An apparatus according to claim 1, wherein the plurality of square pipes are parallelly disposed in a planar direction, with the component pickup portions formed and the hoppers attached at each of the plurality of square pipes, whereby the component supply device cause the plurality of hoppers to move integrally up and down, supplying the chip-type electronic components in each of the hoppers to each of the square pipes; the component conveying device comprises a manifold communicating to each of the hoppers, with positive pressure air being introduced via the manifold into each of the hoppers, conveying the chip-type electronic components in the passageways of each of the square pipes to each of the component pickup portions, with all of the plurality of square pipes, the plurality of hoppers, the component supply device, and the component conveying device being formed so as to be capable of being disposed within a predetermined width in the planar direction.

8. An apparatus according to claim 1, wherein the other end portion of the square pipe in the hopper is formed such that only one of the faces forming the square pipe protrudes.

9. (canceled)
